(19) United States
(12) Patent Application Publication
(10) Pub. No.: US 2016/0192034 A1
(43) Pub. Date: Jun. 30, 2016

(54) TRANSMISSION DEVICE AND TRANSMISSION METHOD, RECEPTION DEVICE AND RECEPTION METHOD, AND COMPUTER PROGRAM

(71) Applicant: SONY CORPORATION, Tokyo (JP)

(72) Inventors: TAKETOSHI YAMANE, Kanagawa (JP); KAZUYUKI TAKAHASHI, Chiba (JP)

(21) Appl. No.: 14/908,354

(22) PCT Filed: Jun. 23, 2014
(86) PCT No.: PCT/JP2014/066595

§ 371 Date: Jan. 28, 2016

(30) Foreign Application Priority Data
Sep. 19, 2013 (JP) 2013-194590

(51) Int. Cl. H04N 21/81; G08B 27/00; H04N 21/854; H04N 21/237; H04N 21/61; H04N 21/488; H04N 21/2362

(52) U.S. Cl. CPC H04N 21/814; H04N 21/4882; G08B 27/008; H04N 21/2362; H04N 21/237; H04N 21/615; H04N 21/85406

(57) ABSTRACT

Emergency alert information is suitably transmitted by utilizing a broadcast service. A preamble section 31 of a transmission frame having a 100 ms interval includes a tuning data section 31A and a reserved bit section 31B, and is made up of a designated total bit length. The tuning data section 31A stores L1 data for tuning to a relevant broadcast channel on the receiving side. Also, the reserved bit section 31B inside the preamble section 31 stores emergency alert information processed by an emergency alert information processing unit 202. In a predetermined message mode, emergency alert information having a predefined message is expressed in a binary format and transmitted in just one frame.

### TECHNICAL FIELD

The technology disclosed is this specification relates to a transmission device and transmission method that transmit emergency alert information, a reception device and reception method that receive emergency alert information, and a computer program.

### BACKGROUND ART

People's lives are affected by a variety of dangerous events, including natural disasters such as earthquakes, tsunamis that accompany earthquakes, typhoons, torrential rains, windstorms, tornados, floods, and forest fires, as well as large-scale terrorism. Additionally, the service status of means of transportation (for example, irregularities in school bus departure and arrival times) and school information (such as, for example, changes in school opening and closing times, cancellation of classes, and school closures due to infectious disease) may also become factors leading to dangerous events. For this reason, people must fee informed of emergency alert information as soon as possible to encourage evacuation,

Emergency alert information during a disaster is typically provided by a government agency, such as the Meteorological Agency. In addition, broadcast services such as television may be utilized to report emergency alert information. For example, in digital terrestrial broadcasting according to the Integrated Services Digital Broadcasting-Terrestrial (ISDB-T; ARIB standard STD-B31) scheme, a signal that transmits so emergency alert, called an emergency alert information descriptor, is defined in a program management table (PMT) packet of program-specific information.

Also proposed is a mechanism that runs on reduced standby power and activates an unpowered reception device to inform the reception device of emergency alert information. A reception device for digital terrestrial broadcasts of the ISDB-T scheme is equipped with a transmission control signal reception function that detects an activation flag for an emergency alert broadcast stored in a transmission and multiplexing configuration control (TMCC) carrier provided for transmitting information related to the demodulation operation of the reception device when power for normal operation of the reception device is not being supplied. When the activation flag for an emergency alert broadcast is 1 (that is, when there is an emergency alert broadcast), the reception device is powered on, thereby encouraging viewing of the emergency alert broadcast on the reception device (for example, see Patent literature 1).

Also disclosed is a digital broadcasting system in which, if the reception device is not powered on or receiving another channel, the digital broadcasting system encourages powering on or changing the channel when there is emergency alert information (for example, see Patent Literature 2). The reception device, upon receiving a TMCC signal and an AC signal in a partial reception segment, plays back other disaster or prevention information as well as video and audio after the device is powered on or the channel is changed.

### SUMMARY OF INVENTION

### Technical Problem

An objective of the technology disclosed in this specification is to provide an excellent transmission device and transmission method capable of suitably transmitting emergency alert information, an excellent reception device and reception method capable of suitably receiving emergency alert information, and a computer program.

A further objective of the technology disclosed in this specification is to provide an excellent transmission device and transmission method, reception device and reception method, and computer program capable of suitably transmitting emergency alert information by utilizing a broadcast service.

### Solution to Problem

The present application is achieved in view of the above-described problem. The technology recited in claim 1 is a transmission device including; an emergency alert information acquisition unit configured to acquire emergency alert information; a broadcast content acquisition unit configured the acquire broadcast content; a transmission frame generation unit configured to generate a transmission frame made up of a payload storing the broadcast content and a prescribed signal, outside the payload, including the emergency alert information; and a transmission unit configured to transmit the transmission frame.

According to the technology recited in claim 2 of the present application, the transmission unit of the transmission device according to claim 1 is configured to transmit the transmission frame on a broadcast channel assigned to a broadcasting station.

According to the technology recited in claim 3 of the present application, the transmission frame generation unit of the transmission device according to claim 1 is configured to insert the prescribed signal in a preamble preceding the payload in the transmission frame.

According to the technology recited in claim 4 of the present application, the transmission frame generation unit of the transmission device according to claim 1 generates the prescribed signal including toning data used for tuning on a receiving side, and storing the emergency alert information in a surplus portion.

According to the technology recited in claim 5 of the present application, the transmission frame generation unit of the transmission device according to claim 1 is configured to store emergency alert information having a predefined message and expressed in a binary format in one prescribed signal.

According to the technology recited in claim 6 of the present application, the transmission frame generation mm of the transmission device according to claim 1 is configured to store one of the emergency alert information using a plurality of prescribed signals.

According to the technology recited in claim 7 of the present application, the transmission frame generation unit of fee transmission device according to claim 1 is configured to store emergency alert information made up of text using a plurality of prescribed signals.

According to the technology recited in claim 8 of the present application, the transmission frame generation limit of the transmission device according to claim 1 is configured to store emergency alert information made up of a designated file format using a plurality of prescribed signals.

According to the technology recited in claim 9 of the present application, the emergency alert information acquisition unit of the transmission device according to claim 1 is configured to acquire emergency alert information made up of a designated file format. According to the technology recited in claim 9 of the present application, the transmission device according to claim 1 further includes an emergency alert information processing unit configured to perform filtering or format conversion on the emergency alert information made up of a designated Hie format. The transmission frame generation unit is configured to store the emergency alert Information processed by the emergency alert information processing unit in the prescribed signal,

According to the technology recited is claim 10 of the present application, the transmission frame generation unit of the transmission device according to claim 1 is configured to use one format from among a format of storing emergency alert information having a predefined message and expressed in a binary format in one prescribed signals a format of storing emergency alert information made up of text using a plurality of prescribed signals, and a format of storing emergency alert information made up of a designated file format using a plurality of prescribed signals, and to specify the format to use inside a prescribed signal.

The technology recited in claim 11 of the present application is a transmission method including: an emergency alert information acquiring step of acquiring emergency alert information; a broadcast content acquiring step of acquiring broadcast content; a transmission frame generating step of generating a transmission frame made up of a payload storing the broadcast content and a prescribed signal, outside the payload including the emergency alert information; and a transmitting step of transmitting the transmission frame.

The technology recited in claim 12 of the present application is a reception device including: a reception unit configured to receive a transmission frame made up of a payload storing broadcast content and a prescribed signal, outside the payload, including emergency alert information; a demodulator configured to demodulate the received transmission frame; a display unit configured to display an image; and a control unit configured to control the display unit. The control unit causes the display unit to display the emergency alert information obtained by demodulating the prescribed signal in the received transmission frame with the demodulator.

According to the technology recited in claim 13 of the present application, the reception unit of the reception device according to claim 12 is configured to receive the transmission frame by tuning to a desired broadcast channel.

According to the technology recited in claim 14 of the present application the reception unit of the reception device according to claim 12 is configured to receive the transmission frame including the prescribed signal in a preamble preceding the payload.

According to the technology recited in claim 15 of the present application, the reception device according to claim 12 farther includes: an audio output unit configured to output audio. The control unit is configured to cause Hie audio output unit to output audio of the emergency alert information obtained by demodulating the prescribed signal with the demodulator.

According to the technology recited in claim 16 of the present application, fee reception device according to claim 12 further includes: a buffer configured to temporarily store the emergency alert information obtained by demodulating the prescribed signal with the demodulator. The control unit is configured to read the emergency alert information from the buffer via a serial interface.

According to the technology recited in claim 17 of the present application, the control unit of the reception device according to claim 12 is configured to wait in a standby state, and the demodulator, upon obtaining valid emergency alert: information iron; the received transmission fame, is configured to activate the control unit by outputting a boot trigger signal.

According to the technology recited in claim 18 of the present application, the demodulator of the reception device according to claim 12 is configured to intermittently activate and cheeks for the prescribed signal In the received transmission frame,

The, technology recited in claim 19 of the present application is a reception method including: a receiving step of receiving a transmission frame made up of a payload storing broadcast content and a prescribed signal, outside the payload, including emergency alert information; a demodulating step of demodulating the received transmission frame; and a displaying step of displaying, on the display unit, the emergency alert information obtained by demodulating the prescribed signal in the received transmission frame,

The technology recited in claim 20 of the present application is a computer program stated in a computer-readable format so as to cause a computer to function as: a reception unit configured to receive a transmission frame made up of a payload storing broadcast content and a prescribed signal, outside the payload, including emergency alert information; a demodulator configured to demodulate the received transmission frame; a display unit configured to display an image; and a control unit configured to cause the display unit to display the emergency alert information obtained by demodulating the prescribed signal in the received transmission frame with the demodulator.

A computer program according to claim 20 of this application defines a computer program stated in a computer-readable format so that designated processing is realized on a computer. Stated differently, by installing the computer program according to claim 20 of this application onto a computer, cooperative action is exhibited on the computer, and operational advantages similar to the reception device according to claim 12 of this application may be obtained.

### Advantageous Effects of Invention

According to the technology disclosed in this specification, it is possible to provide an excellent transmission device and transmission method, reception device and reception method and computer program capable of suitably transmitting emergency alert information by utilizing a broadcast service.

According to the technology disclosed in this specification, emergency alert information is stored in a prescribed signal portion that is periodically transmitted for tuning to a broadcast channel, and thus the emergency alert information may be transmitted reliably to each reception device that receives the broadcast signal. Such a prescribed signal is mapped in front of the payload (in the preamble) in a transmission frame of the broadcast signal. Consequently, on the reception device side, a message may be provided to users immediately and with low load by simply decoding the prescribed signal (in other words, by simply processing the physical layer or a lower layer of the communication protocol, without decoding the broadcast data itself).

In other words, according to the technology disclosed in this specification, emergency alert information at various granularities may be transmitted in a single prescribed signal or over multiple prescribed signals.

In addition, according to the technology disclosed in this specification, the desired emergency alert information to report may be expressed in a format of index information prescribed in advance, and thus may he reduced in size and transmitted with a single prescribed signal. On the receiving side, users may be alerted immediately and with low load (by simply processing the physical layer or a lower layer of the communication protocol) from a single prescribed signal.

In addition, the effects described in the present specification are merely illustrative and demonstrative, and not limitative. In other words the technology according to the present disclosure can exhibit other effects that are evident to those skilled in the art along with or instead of the effects based on the present specification.

Other objects, features, and advantages of the technology disclosed in this specification will be made clear later by a more detailed explanation that is based on the embodiments of the present disclosure and the appended drawings.

### Brief Description of Drawings

FIG. 1 is a diagram that schematically illustrates an example configuration of an emergency alert information transmission system 1.

FIG. 2 is a diagram that schematically illustrates an internal configuration of a transmission device 200.

FIG. 3 is a diagram that schematically illustrates an example format of a transmission frame of a broadcast signal 210 conforming to a designated broadcast standard.

FIG. 4A is a diagram illustrating example syntax of emergency alert information stored in a reserved bit section 31B.

FIG. 4B is a diagram illustrating example syntax of emergency alert information stored in a reserved bit section 31B.

FIG. 4C is a diagram illustrating example syntax of emergency alert information stored in a reserved bit section 31B.

FIG. 5 is a diagram illustrating a definition of each statement used in FIGS. 4A to 4C.

FIG. 6 is a flowchart illustrating a processing sequence by which a transmission device 200 transmits (broadcasts) emergency alert information to a reception device 300.

FIG. 7 is a diagram illustrating an example internal configuration of a reception device 300.

FIG. 8 is a diagram illustrating a time chart for the reception device 300 from the receiving of a transmission frame transmitted from a transmission device 200 to the displaying of an alert information message.

FIG. 9 is a diagram illustrating another example format of a transmission frame that includes emergency alert information in the preamble.

FIG. 10 is a diagram illustrating example syntax of emergency alert information (EWS) stored in an emergency alert information section 911B in a predetermined message mode format.

### DESCRIPTION OF EMBODIMENTS

Hereinafter, an embodiment of the technology disclosed in this specification will be described hi detail and with reference to the drawings,

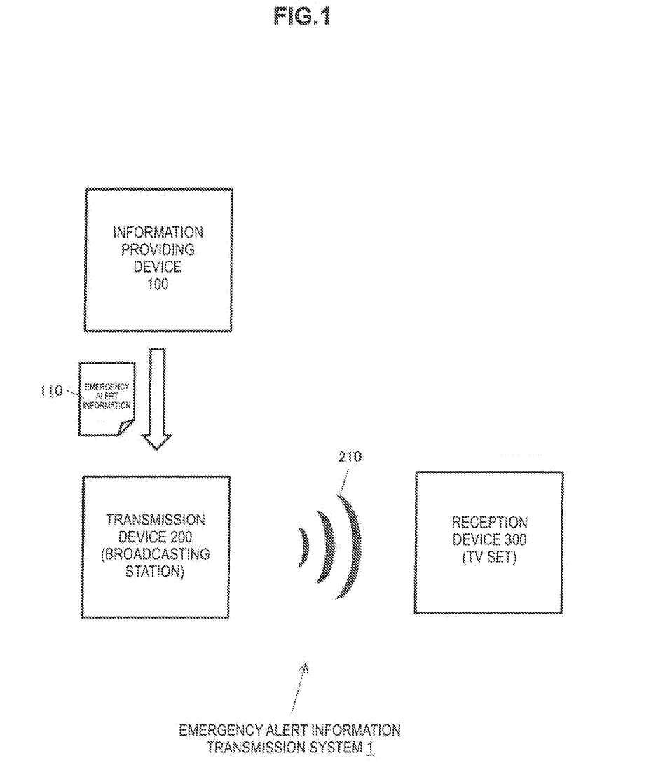

FIG. 1 schematically illustrates an example configuration of an emergency alert information transmission system 1. The emergency alert information transmission system 1 illustrated in the drawing is made up of an information providing device 100 that provides emergency alert information, a transmission device 200 that transmits provided emergency alert information 110, and a reception device 300 that receives emergency alert information and informs nearby users.

The information providing device 100 is administered by the Meteorological Agency or some other government agency, for example and provides the transmission device 200 with emergency alert information 110 that warns about the occurrence of various emergency situations, including natural disasters such as earthquakes, tsunamis that accompany earthquakes, typhoons, torrential rains, windstorms, tornados, floods, and forest fires, as well as large-scale terrorism, and additionally, the service status of means of transportation and school information.

The configuration of the communication link connecting the information providing device 100 and the transmission device 200 is arbitrary. For example, a public network, such as the Internet, or a dedicated line may be used for the communication link. Alternatively, emergency alert information entered on a paper medium may be sent to the user of the transmission device 200 using facsimile or the like.

In addition, the format in which the emergency alert information 110 is described is arbitrary. For example, the emergency alert information 110 may be described in the format of a structure description language such as Extensible Markup Language (XML). For example, many organizations, such as the United States Department of Homeland Security, the United States Geological Survey (USGS), and the Canadian government, exchange information about a wide variety of warnings and emergency alerts using a simple standardized XML data format called the Common Alerting Protocol (CAP). The information providing device 100 may provide the transmission device 200 with emergency alert information 110 in CAP format.

The transmission device 200 is administered by a broadcasting station that provides digital terrestrial broadcasting services, for example, and broadcasts a broadcast signal 210 in a prescribed format, such as a television program. In FIG. 1, only one transmission device 200 is illustrated for the sake of simplicity, but this should be understood as a transmission device 200 being installed in each broadcasting station. In fee present embodiment, the transmission device 200 inserts emergency alert information in a format discussed later into the broadcast signal 210 that, carries moving image content such as a television program, and broadcasts the result.

Note that in FIG. 1, the transmission device 200 is configured to receive emergency alert information 110 from the information providing device 100 administered by a government agency, but the transmission device 200 may also acquire emergency alert, information from a source of information other than the information providing device 100. Additionally, the information providing device 100 is not necessarily required to be administered by a government agency, and may also be administered by a private group or the broadcasting station itself.

The reception device 300 corresponds to a television set or a set-top box, for example, and is internally equipped with a tuner that receives the digital terrestrial broadcast signal 210. It is herein supposed that one or more television sets or set-top boxes are installed in each general household, but in FIG. 1, only one reception device 300 is illustrated for the sake of simplicity. The reception device 300, upon decoding emergency alert information inserted in a format discussed later into a received broadcast signal, displays an alert message on the TV screen, outputs audio of an alert sound, and the like to immediately warn users viewing the television program,

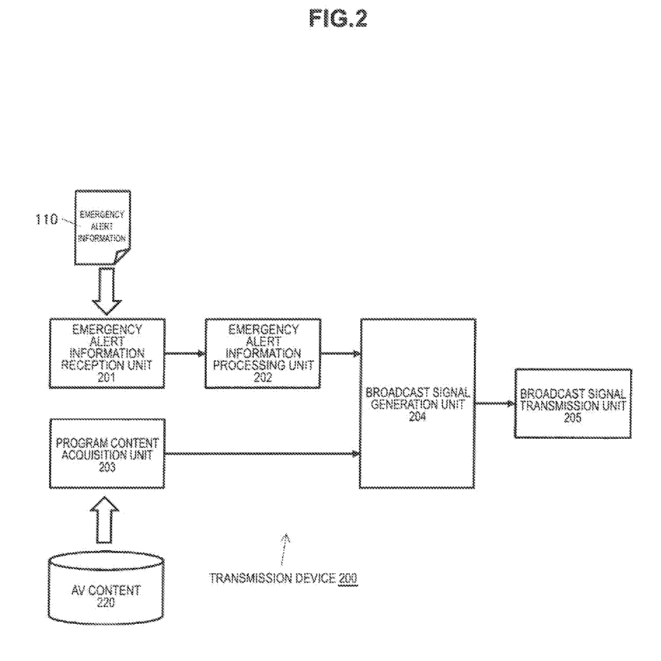

FIG. 2 schematically illustrates an internal configuration of the transmission device 200. The transmission device 200 illustrated in the drawing is made up of an emergency alert information reception unit 201, an emergency alert information processing unit 202, a program content acquisition unit 203, a broadcast signal generation unit 204, and a broadcast signal transmission unit 205.

The emergency alert information reception unit 201 receives emergency alert information 110 stated in CAP format or some other arbitrary format from the information providing device 100 via a communication link which may be a public network, such as the Internet or a dedicated line (none illustrated).

The emergency alert information processing unit 202 performs processes on the received emergency alert information 110, such as a filtering process that removes unwanted information (for example, information unrelated to the broadcast area), and file format conversion. Additionally, in the present embodiment, multiple formats are prepared for transmitting emergency alert information from the transmission device 200 to the reception device 300 (discussed later), and the emergency alert information processing unit 202 decides which format to use for transmitting the emergency alert information. For example, the emergency alert information processing unit 202 may decide the transmission format by analyzing the content of the emergency alert information, or decide the transmission format according to manual operations by a user (the policy at the broadcasting station).

The program content acquisition unit 203 acquires the AV content that forms the main broadcast program. The program content acquisition unit 203 may retrieve relevant AV content according to the broadcast time from a storage location for prerecorded AV content, but may also be supplied with live AV content from a studio or a filming location.

The broadcast signal generation unit 204 generates a broadcast signal in a format conforming to a designated broadcast standard. The broadcast standard may be, for example, an Advanced Television Systems Committee (ATSC) standard adopted in countries such as the United States of America, Canada, Mexico, and the Republic of Korea. In the present embodiment, the broadcast signal is made up of a preamble used to tune to a broadcast channel on the receiving side, and a payload of fixed length or variable length storing the AV content that forms the main program. In the present embodiment, the broadcast signal generation unit 204 stores emergency alert information inside the preamble, in a format decided by the emergency alert information processing unit 202, but further details will be deferred until later.

The broadcast signal transmission unit 205 performs processing on the generated broadcast signal, including coding, digital modulation such as orthogonal frequency-division multiplexing (OFDM), AD conversion, upconversion to the RF band (a frequency channel allocated to the relevant broadcasting station), and power amplification, and sends out the resulting broadcast signal from a transmit antenna such as a radio tower (not illustrated).

Note that not all of the function modules 201 to 205 are required to be physically disposed inside a single device, and an embodiment is also possible in which at least some of the function modules are configured as physically independent device from another function module. For example, the emergency alert information processing unit 202 may also be configured as an emergency alert information processing server on the Internet (not illustrated).

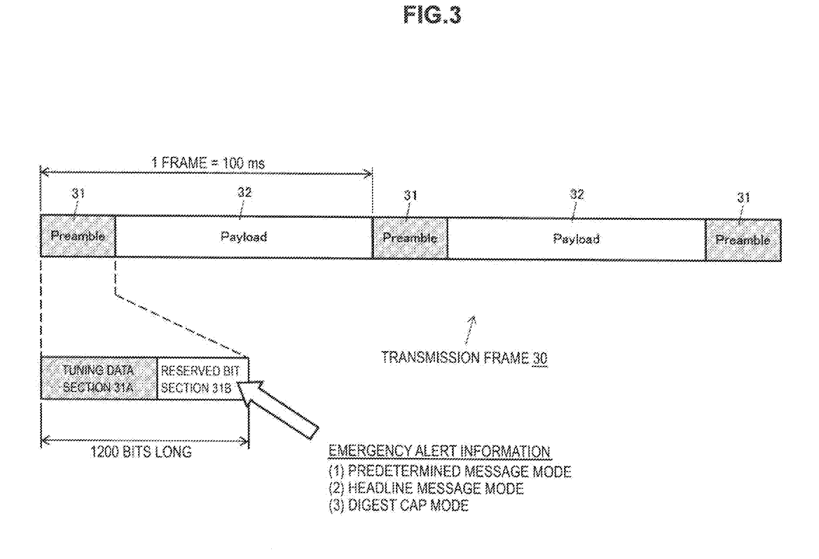

FIG. 3 schematically illustrates an example format of a transmission frame of a broadcast signal conforming to a designated broadcast standard. In the illustrated example, a transmission frame 30 is made up of a preamble section 31 used to tone to a broadcast channel on the receiving side, and a payload 32 of fixed length storing the AV content that forms the main program as well as auxiliary data. One frame of the transmission frame 30 varies depending on the transmission scheme. In the present embodiment, one frame is taken to be 100 ms as an example.

The preamble section 31 includes a tuning data section 31A and a reserved bit section 31B. The total bit length of the preamble section 31 varies depending on the transmission scheme. In the present embodiment, the total bit length of the preamble section 31 is taken to be 1200 bits as an example. The tuning data section 31A stores L1 data, which is data for tuning to a relevant broadcast channel on the receiving side (critical data for tuning). Also, in the present embodiment, the reserved bit section 31B inside the preamble section 31 stores emergency alert information processed by the emergency alert information processing unit 202. Since the transmission frame is 100 ms, emergency alert information arrives at the receiving side in 100 ms intervals. Since the emergency alert information is stored in the preamble section 31 and not the payload 32, it should be understood that the present scheme is dearly different from the ISDB-T scheme which transmits emergency alert information as a control packet (FMT) within the transport stream (TS).

In the present embodiment, the following three variations are prepared as formats in which to transmit emergency alert information,
(1) Predetermined message mode
(2) Headline message mode
(3) Digest CAP mode

The predetermined message mode is a format that expresses emergency alert information having a message determined in advance in a binary format of small size, and transmits the emergency alert information in just one frame (that is, one preamble). There are various events for which an emergency alert should be issued, including natural disasters such as earthquakes, tsunamis that accompany earthquakes, typhoons, torrential rains, windstorms, tornados, floods, and forest fires, as well as large-scale terrorism, and additionally, the service status of means of transportation and school information, but by substituting index information of small size expressed in a binary format for which standard messages reporting each event are prescribed in advance, emergency alert information may be stored inside one preamble. For example, an index number in a binary format is assigned to an event that should be reported, and just the index number is stored m the reserved bit section 31B inside the preamble. On the receiving side, an index number decoded from any one preamble arriving at 100 ms intervals may be used to search for the original emergency alert information, and an alert may be issued immediately. Additionally, since simply decoding the preamble section 31 is sufficient and decoding the payload 32 is not necessary, on the receiving side, a standard message may be issued immediately and with low load (by simply processing the physical layer or a lower layer of the communication protocol).

The headline message mode is a format that configures emergency alert information as headline text information stated in text format, and transmits the emergency alert information using 10 to 20 transmission frames. Since emergency alert information is stated as text rather than being encoded in a binary format, the power of expression becomes richer. Consequently, on the receiving side, emergency alert information with more detailed content than a standard message may be provided. Additionally, since simply decoding the preamble is sufficient and decoding the payload is not necessary, on fee receiving side, an emergency alert message may be issued with low load (by simply processing the physical layer or a lower layer of the communication protocol). However, since an alert cannot be issued until 10 to 20 frames have been received, this mode is inferior to the predetermined message mode in terms of immediacy.

The digest CAP mode is a format that performs a digest process, such as filtering and file format conversion, on emergency alert information in CAP format provided by the information providing device 100, and then transmits the emergency alert information. The size of emergency alert information in CAP format is large even alter performing digest processing, and is transmitted rising a number of frames in excess of 20 frames. Although it becomes possible to provide even more detailed emergency alert information than headline text information, the processing time from when die transmission of emergency alert information is started until an alert is issued on the receiving side becomes even longer than headline message mode,

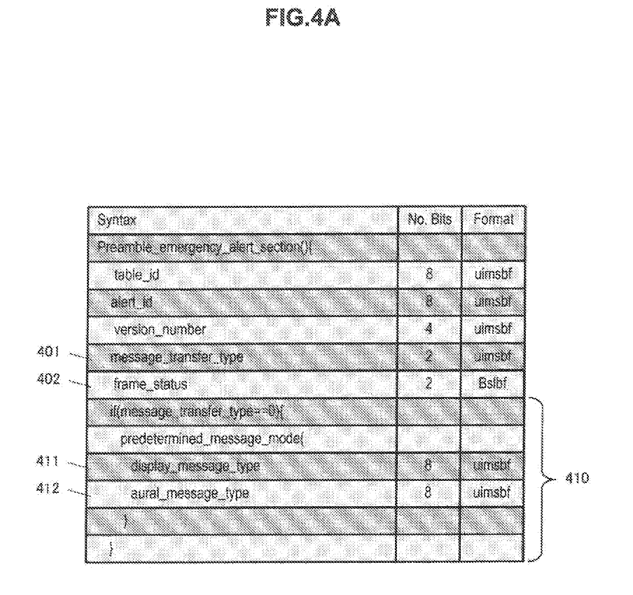

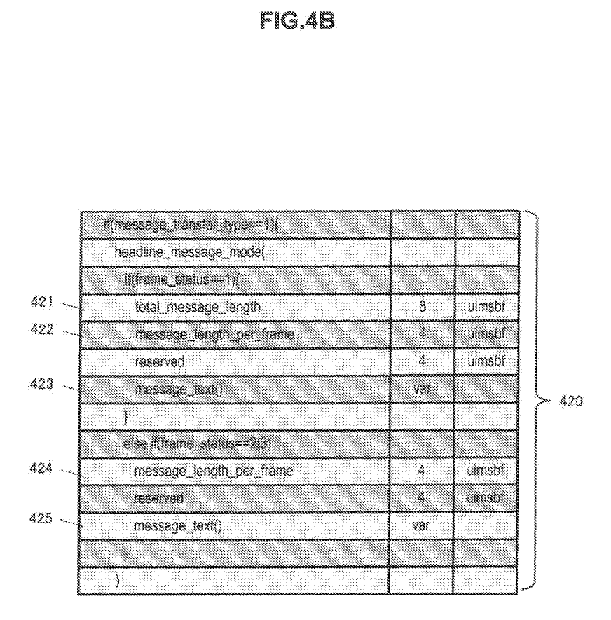

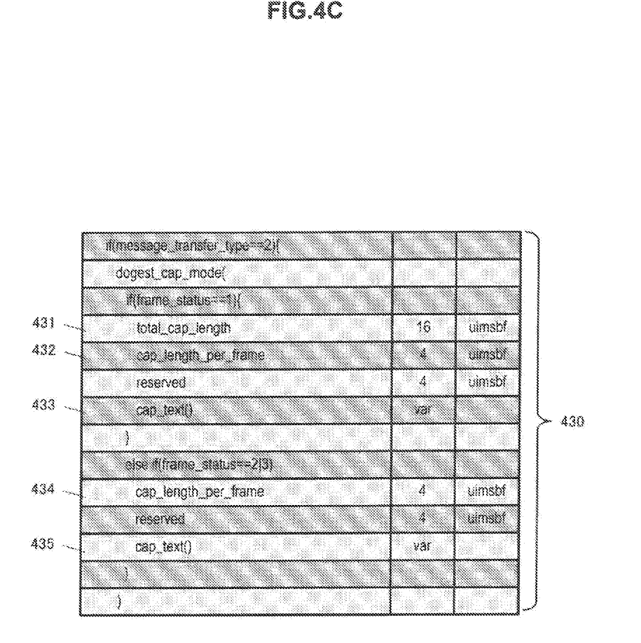

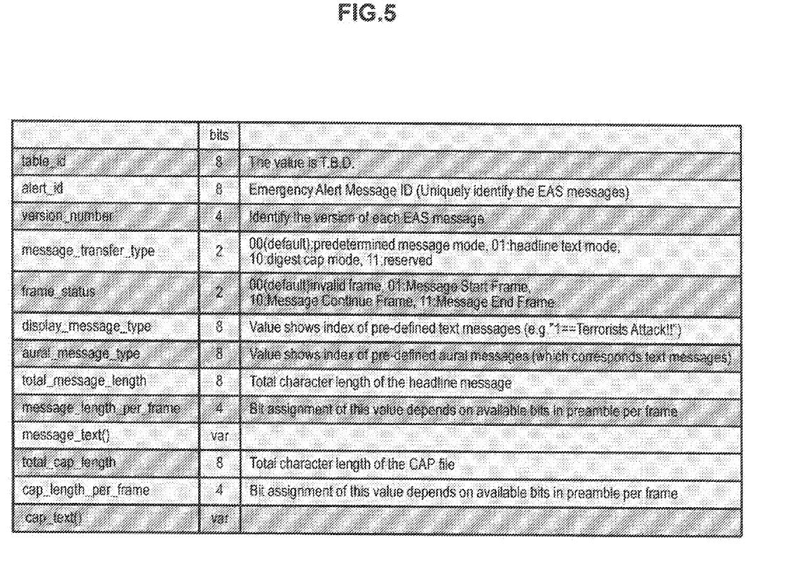

FIGS. 4A to 4C illustrate example syntax of emergency alert, information stored in the reserved bit section 31B. Also, FIG. 5 illustrates a definition of each statement used in FIGS. 4A to 4C.

First, the definition of each statement will be described with reference to FIG. 5 in order from the top. The table_id is an 8-bit value to be decided by future discussion. The alert_id is an 8-bit value expressing identification information of the emergency alert information, and uniquely Identifies an Emergency Alert System (EAS) message. The version_number is a 4-bit value expressing identification information of fee version of each EAS message. The message transfer type is a 2-bit value expressing the format in which the emergency alert information is transmitted, in which 00 (the default value) is predetermined message mode, 01 is headline text mode, 10 is digest CAP mode, and 11 is a reserved value. The frame_status is a 2 bit value expressing the status of the relevant transmission frame, in which 00 (the default value) indicates an invalid frame, 01 indicates the start frame of the emergency alert information message, 10 indicates a continue frame of the emergency alert information message, and 11 indicates the end frame of the emergency alert information message. The display_message_type is an 8-bit value expressing an index of predefined text messages (messages are prescribed in advance, such 1 indicating “Terrorists Attack!”, for example). The aural_message_type is an 8-bit value expressing an index of predefined aural messages, which correspond to the predefined text messages. The total_message_lengtb is an 8-bit value expressing the total character length of a headline text message. The message_length_per_frame is a 4-bit value expressing the character length of the message per frame, but the bit assignment of this value depends on the number of available bits inside the preamble per frame. The message_text( ) is a variable into which the text of a headline text message is substituted. The total_cap_length is an 8-bit value expressing the total character length of a CAP file. The cap_length_per_frame is a 4-bit value expressing the character length storing data from inside die CAP file per frame, but the bit assignment of this value depends on the number of available bits inside the preamble per frame. The cap_text( ) is a variable into which text from inside the CAP file is substituted.

Next, the syntax of emergency alert information will be described with reference to FIGS. 4A to 4C. With the 2-bit message_transfer_type field indicated by the reference number 401, the format in which the emergency alert information is transmitted, being one of predetermined message mode, headline message mode, or digest CAP mode, is indicated in the preamble of the relevant frame. Also, with the 2-bit frame_status field indicated by the reference number 402, the relevant frame is indicated as corresponding to a start, continue, or end position of the emergency alert information message.

In FIG. 4A, the section indicated by the reference number 410 is the syntax is the case of predetermined message mode (message transfer type is 0). In this case, as indicated by the reference number 411, the format of the message to display on-screen as emergency alert information (display_message_type) is stated using 8 bits. Also, as indicated by the reference number 412, the format of the message to output as audio (aural_message_type) is stated using 8 bits.

Also, in FIG. 4B, the section indicated by the reference number 420 is the syntax in the case of headline message mode. In this case, in the start frame of the message (frame_status is 1), as indicated by the reference number 421, the data, length of the entire headline message to transmit (total_message_length) is stated using 8 bits, as indicated by the reference number 422, the data length of the message stored in She current frame (message_length_per_frame) is stated using 4 bits, and as indicated by the reference number 423, the text of the message (message_text) is stated. Also, in the continue and end frames of the message (frame_status is 2 or 3), as indicated by the reference number 424, the data length of the message stored in the current frame (message_length_per_frame) is stated using 4 bits, and as indicated by the reference number 425, the text of the message (message_text) is stated.

Also, in FIG. 4C, the section indicated by the reference number 430 is the syntax in the case of digest CAP mode. In this case, in the start frame of the message (frame_status is 1), as indicated by the reference number 431, the data length of the entire headline message to transmit (total_message_length) is stated using 16 bits, as indicated by the reference number 432, the data length of the CAP file stored in the current frame (cap_length_per_frame) is stated using 4 bits, and as indicated by the reference number 433, the text from the content of the CAP file (cap_text) is stated. Also, in the continue and end frames of the message (frame_status is 2 or 3), as indicated by the reference number 434, the data length of the CAP file stored in the current frame (cap_length_per_frame) is stated using 4 bits, and as indicated by the reference number 435, the text from, the content of the CAP file (cap_text) is stated.

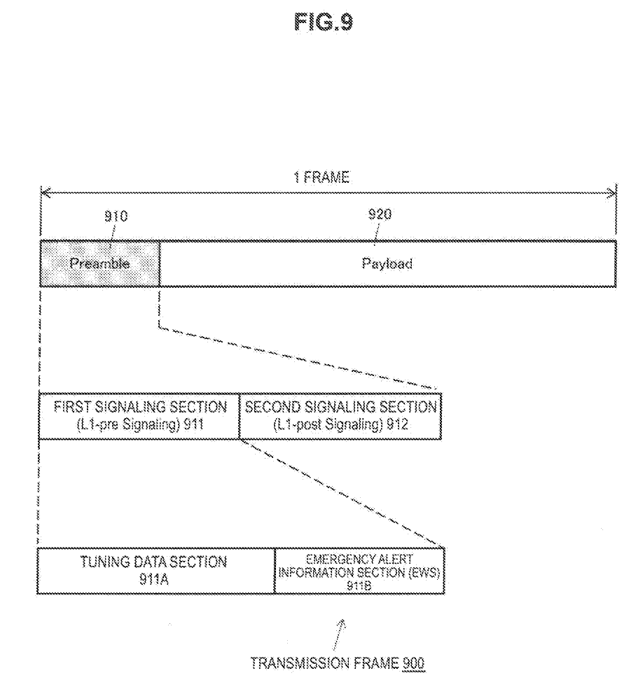

FIG. 3 illustrates an example format of s transmission frame including emergency alert information inside the preamble. FIG. 9 illustrates another example format of a transmission frame that includes emergency alert information inside the preamble. The transmission frame 900 illustrated in the drawing is made up of a preamble section 910 and a payload 920, hot the preamble section 910 is made up of multiple signaling sections. In the illustrated example, the preamble section 910 is taken to include a first signaling section (L1-pre Signaling) 911 and a second signaling section (L1-post Singnaling) 912. When multiple signaling sections are provided, the error-correcting codes and phase modulation scheme may be switched in every signaling section. Of these, the first signaling section 911 is made up of a tuning data section 911A used to tune to a broadcast channel on the receiving side, and an emergency alert information section (EWS) 911B. In the emergency alert information section 911B, emergency alert information processed by the emergency alert information processing unit 202 is stored. Since the emergency alert information is stored in the preamble section 911, it should be understood that the present scheme is clearly different from the ISDB-T scheme which transmits emergency alert information as a control packet (PMT) within the transport stream (TS).

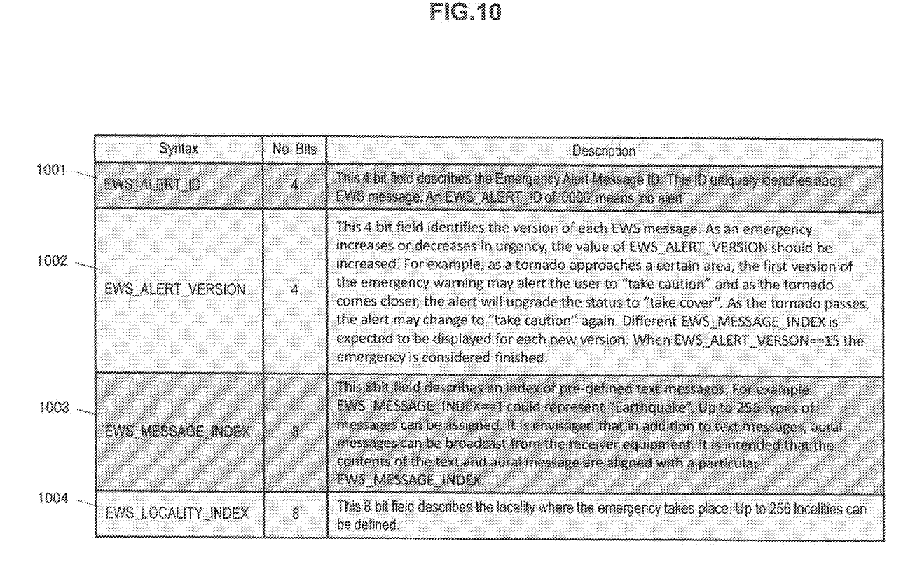

Additionally, FIG. 10 illustrates example syntax of emergency alert information (EWS) stored in the emergency alert information section 911B in predetermined message mode format The EWS_ALERT_ID indicated by the reference number 1001 is a field stating emergency alert message identification information. This identification information uniquely identifies each emergency alert message. An EWS_ALERT_ID of “0000” means “no alert”. The EWS_ALERT_VERSION indicated by the reference number 1002 is a field identifying the version of the emergency alert message. As the emergency situation increases or decreases in urgency, the value of EWS_ALERT_VERSION should be increased. For example, as a tornado approaches a certain area, the first version of the emergency alert warns users to “take caution”. Subsequently, as the tornado comes closer, the alert, upgrades the status to “take cover”. As the tornado passes, the alert changes back to “take caution”. A different EWS_MESSAGE_INDEX is expected to be displayed for each new version. When the value of EWS_MESSAGE_VERSION is 15, the emergency situation is considered to be over. The EWS_MESSAGE_INDEX indicated by the reference number 1003 is a field stating the index of the predefined text message. For example, an EWS_MESSAGE_INDEX with a value of 1 represents the predefined text message “Earthquake”. The EWS_MESSAGE_INDEX may he assigned to up to 256 types of messages. It is envisaged that in addition to text messages, aural messages may be broadcast from the reception device 300. It is intended that the contents of the text and aural message are aligned with a particular EWS_MESSAGE_INDEX. The EWS_LOCALITY_INDEX indicated by the reference number 1004 is a field indicating the locality where fee emergency situation takes place. The EWS_LOCALITY_INDEX may he defined for up to 256 localities.

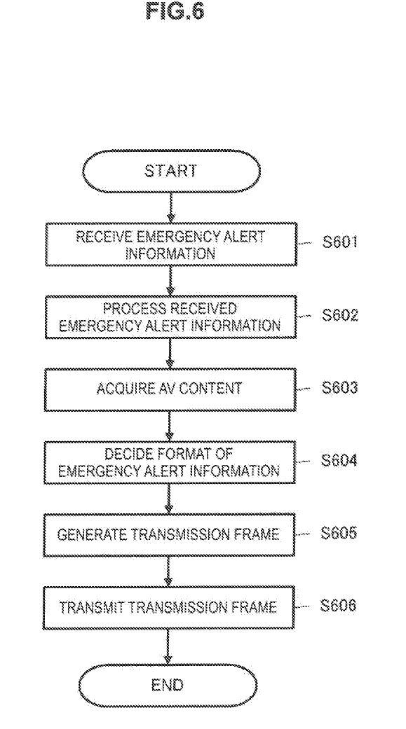

FIG. 6 illustrates in flowchart format a processing sequence by which the transmission device 200 transmits (broadcasts) emergency alert information to the reception device 300.

Firsts the emergency alert interrelation reception unit 201 receives emergency alert information 110 stated in CAP file format or some other arbitrary data format from the information providing device 100 via a communication link which may be a public network, sack as the internet, or a dedicated line (step S601).

Next, the emergency alert: information processing unit 202 performs processes on the received emergency alert information 110, such as a filtering process that removes unwanted information (for example, information unrelated to the broadcast area), and file format conversion (step S602).

Also, the program content acquisition unit 203 acquires the AV content that forms the main broadcast program (step S603).

Next, the emergency alert information processing unit 202 decides which of the formats (1) to (3) discussed above to use for transmitting emergency alert information to the reception device 300, and generates emergency alert information in accordance with that format (step S604).

Next, the broadcast signal generation unit 204 generates a transmission frame made up of a preamble used to tune to a broadcast channel on the receiving side, and a payload of fixed length or variable length storing the AV content that forms the main program (step S605). At this point, the broadcast signal generation unit 204 stores the emergency alert information inside the preamble.

Subsequently, the broadcast signal transmission unit 205 performs processes such as digital modulation, DA conversion, upconversion to the RF band, and power amplification on the generated transmission frame, and sends out the transmission frame from a transmit antenna such as a TV tower (step S606).

The reception device 300, upon decoding the emergency alert information inserted into the preamble of a transmission frame received from a transmission device, displays the message of the emergency alert on-screen., outputs audio, or the like.

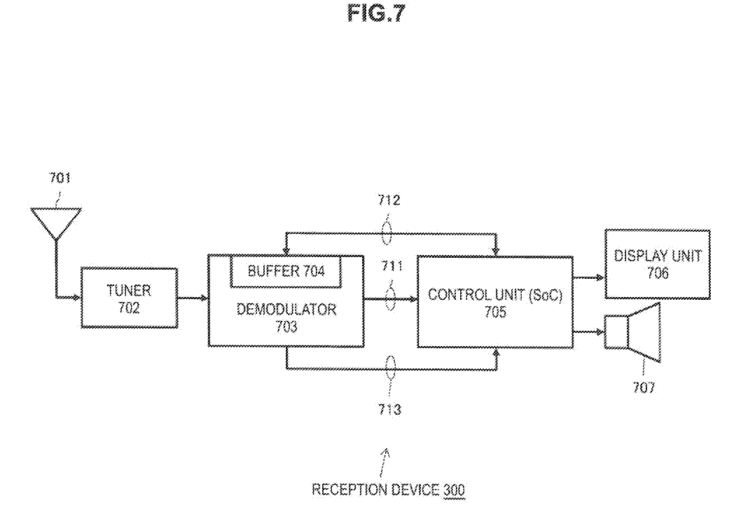

The reception device 300 corresponds to a television set or a set-top box, for example, and is equipped with a tuner that receives the digital terrestrial broadcast signal 210. FIG. 7 illustrates an example internal configuration of the reception device 300.

A toner 702 performs modulation on the components of a designated frequency channel from a broadcast signal received by an antenna 701.

A demodulator 703 performs a demodulation process on the tuned broadcast signal In the present embodiment, the demodulator 703 features a buffer 704 for temporarily storing emergency alert information. In other words, the demodulator 703 performs demodulation inside the preamble section 31 of the transmission frame 30, and when valid emergency alert information is detected inside the preamble section 31, the demodulator 703 stores the emergency alert information hi the buffer 704. Note that the demodulator 703 is not required to continuously perform a demodulation process for detecting the preamble section 31, and may also save power by intermittently activating and performing the detection of the preamble section 31.

A control unit 705 centrally controls the operation of the reception device 300 overall The control unit 705 performs a process causing received broadcast content and emergency alert information messages to be displayed on-screen on a display unit 706 or output as audio from a speaker 707. The control unit 705 is made up of a system on a chip (SoC), for example.

In the present embodiment, besides the demodulator 703 and the control unit 705 being connected by a signal line 711 for payload data transmission, the control unit 705 has a control bus 712 for controlling the demodulator 703. The control unit 705 directly reads data stored in the buffer 704 (discussed earlier) inside the demodulator 703 via the control bus 712. The control bus 712 is envisaged to be made up of a serial interface such as Inter-Integrated Circuit (I²C), for example, but is not limited thereto.

In addition, the demodulator 703 also features a boot trigger signal 713 for booting the SoC inside the control unit 705 which is in a standby state. When valid emergency alert information is detected inside the preamble section 31, the demodulator 703 stores the emergency alert information in the buffer 704, and also outputs the boot trigger signal 713 to boot the SoC which is in a standby state.

In the case of such a configuration, after the SoC boots from a standby state, the control unit 705 is able to read out the emergency alert information being stored in the buffer 704 inside the demodulator 703 via the FC interface 712, and immediately (that is, before processing the payload of die transmission frame) conduct a process of displaying an emergency alert information message on-screen on the display unit 706, outputting audio from the speaker 707, and the like.

Additionally, if the SoC inside the control unit 705 is equipped with an emergency operation mode with a short boot time and capable of processing only the preamble section, in addition to a normal operation mode capable of completely processing the payload of a transmission frame, the required time between the arrival of a transmission frame at the reception device 300 and the display of the emergency alert information message may be shortened further. For example, in the case of transmitting emergency alert information in predetermined message mode, it is not necessary to perform advanced processing such as analyzing text information or CAP data, and it is sufficient for a simple processing fraction module inside the SoC to be operating. Thus, the boot time may be shortened further.

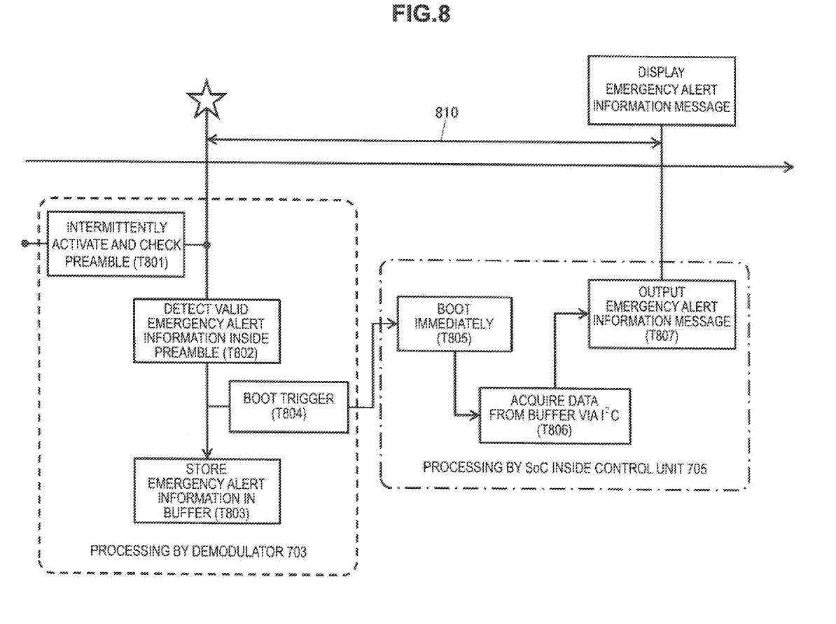

FIG. 8 illustrates a time chart for the reception device 300 from the receiving of a transmission frame transmitted from a transmission device 200 to the displaying of an alert information message.

The demodulator 703 intermittently activates and cheeks the data in the preamble section 31 of a transmission frame 30 received by the antenna 701 (S801).

Subsequently, when valid emergency alert information is detected inside the preamble section 31 (T802), the demodulator 703 stores the emergency alert information in the buffer 704 (T803), and also outputs the boot trigger signal 713 to boot the SoC inside the control unit 705 which is in a standby state (T804).

After the SoC boots from a standby state (T805), the control unit 705 reads out the emergency alert information being stored in the buffer 704 inside the demodulator 703 via the 12C interface 712 (T806), and displays an emergency alert information message on-screen on the display unit 706, outputs audio from the speaker 707, and the like (T807).

In FIG. 8, the segment indicated by the reference number 810 is the required time between the arrival of a transmission frame at the reception device 300 and the display of the emergency alert information message. If the boot time is short, the SoC inside the control unit 705 is able to display the emergency alert information message in a short time, even from a standby state. For example, in the case of transmitting emergency alert information in predetermined message mode, it is not necessary to perform advanced processing such as analyzing text information or CAP data, and it is sufficient for a simple processing function module inside the SoC to be operating. Thus, the boot time may be shortened further.

### CITATION LIST

### Patent Literature

Patent Literature 1: JP 2006-319771A

Patent Literature 2: JP 2007-243936A

### INDUSTRIAL APPLICABILITY

The foregoing thus describes the technology disclosed in this specification in detail and with reference to a specific embodiment. However, it is obvious that persons skilled in the art may make modifications and substitutions to this embodiment without departing from the spirit of the technology disclosed in this specification.

The technology disclosed in this specification may he applied to broadcasting systems of various types that broadcast content using transmission frames including a preamble, and thereby transmit emergency alert information. For example, the technology disclosed in this specification may be applied to a broadcasting system based on the ATSC broadcast standard adopted in countries such as the United States of America, but the range of application is not limited thereto. Additionally, the technology disclosed in this specification may be applied similarly to broadcasting systems conforming to a broadcast standard dust adds data to a payload in a format other than a preamble. Furthermore, the technology disclosed in this specification may be applied similarly not to broadcasting but to wired or wireless communication systems such as IP networks.

In short, the present technology has been disclosed in a form of illustration and should not be interpreted limitedly. To determine the gist of the present disclosure, patent claims should be taken into account.

Additionally, the present technology may also he configured as below.
(1)

A transmission device including:

an emergency alert information acquisition unit configured to acquire emergency alert information;

a broadcast content acquisition unit configured to acquire broadcast content;

a transmission frame generation unit configured to generate a transmission frame made up of a payload storing the broadcast content and a prescribed signal, outside the payload, including the emergency alert information; and

a transmission unit, configured to transmit the transmission frame.
(2)

The transmission device according to (1), wherein
the transmission unit transmits the transmission trams on a broadcast channel assigned to a broadcasting station.
(3)

The transmission device according to (1), wherein

the transmission frame generation unit inserts the prescribed signal in a preamble preceding the payload in the transmission frame,
(3-1)

The transmission device according to (3), wherein

if the preamble is made up of a plurality of signaling sections, the transmission frame generation unit includes the emergency alert information in one of the signaling sections,
(4)

The transmission device according to (1), wherein

the transmission frame generation unit generates the prescribed signal including tuning data used for tuning on a receiving side, and storing the emergency alert information in a surplus portion.
(5)

The transmission device according to (1), wherein

the transmission frame generation unit stores emergency alert information having a predefined message and expressed in a binary format in one prescribed signal
(6)

The transmission device according to (3), wherein

the transmission frame generation unit stores one of the emergency alert information using a plurality of prescribed signals.
(7)

The transmission device according to (1), wherein

the transmission frame generation unit stores emergency alert information made up of text using a plurality of prescribed signals.
(8)

The transmission device according to (1), wherein

the transmission frame generation unit stores emergency alert information made up of a designated file format using a plurality of prescribed signals.
(9)

His transmission device according to (8), wherein

the emergency alert information acquisition unit acquires emergency alert information made up of a designated file format,

the transmission device further includes an emergency alert information processing unit configured to perform filtering or format conversion on the emergency alert information made up of a designated file format, and

the transmission frame generation unit stores the emergency alert information processed by the emergency alert information processing unit in the prescribed signal.
(10)

The transmission device according to (1), wherein

the transmission frame generation unit uses one format from among a format of storing emergency alert information having a predefined message and expressed in a binary format in one prescribed signal, a format of storing emergency alert information made up of text using a plurality of prescribed signals, and a format of storing emergency alert information made up of a designated file format using a plurality of prescribed signals, and specifies the format to use inside a prescribed signal.
(11)

A transmission method including:

an emergency alert information acquiring step of acquiring emergency alert information;

a broadcast content acquiring step of acquiring broadcast content;

a transmission frame generating step of generating a transmission frame made up of a payload storing the broadcast content and a prescribed signal, outside the payload, including the emergency alert information; and

a transmitting step of transmitting the transmission frame,
(12)

A reception device including;

a reception unit configured to receive a transmission frame made up of a payload storing broadcast content and a prescribed signal, outside the payload, including emergency alert information;

a demodulator configured to demodulate the received transmission frame;

a display unit configured to display an image; and

a control unit configured to control the display unit, wherein

the control unit causes the display unit to display the emergency alert information obtained by demodulating the prescribed signal in the received transmission frame with the demodulator.
(13)

The reception device according to (12), wherein

the reception unit receives the transmission frame by tuning to a desired broadcast channel.
(14)

The reception device according to (12), wherein

the reception unit receives the transmission frame including the prescribed signal in a preamble preceding the payload.
(14-1)

The reception device according to (14), wherein

if the preamble is made up of a plurality of signaling sections, the control unit causes the emergency alert information included in one of the signaling sections to be displayed.
(15)

The reception device according to (12), further including:

an audio output unit configured to output audio, wherein

the control unit causes the audio output unit to output audio of the emergency alert Information obtained by demodulating the prescribed signal with the demodulator.
(16)

The reception device according to (12), further including:

a buffer configured to temporarily store the emergency alert information obtained by demodulating the prescribed signal with the demodulator, wherein

the control unit reads the emergency alert information from the buffer via a serial interface.
(17)

The reception device according to (12), wherein

the control unit waits in a standby state, and

the demodulator, upon obtaining valid emergency alert information from the received transmission frame, activates the control unit by outputting a boot trigger signal
(18)

The reception device according to (12), wherein

the demodulator intermittently activates and checks for the prescribed signal in the received transmission frame.
(19)

A reception method including:

a receiving step of receiving a transmission frame made up of a payload storing broadcast content and a prescribed signal, outside the payload, including emergency alert information;

a demodulating step of demodulating the received transmission frame; and

a displaying step of displaying, on the display unit, the emergency alert information obtained by demodulating the prescribed signal in the received transmission frame.
(20)

A computer program stated in a computer-readable format so as to cause a computer to function as:

a reception unit configured to receive a transmission frame made up of t payload storing broadcast content and a prescribed signal, outside the payload, including emergency alert information;

a demodulator configured to demodulate the received transmission frame;

a display unit configured to display an image; and

a control unit configured to cause the display unit to display the emergency alert information obtained by demodulating the prescribed signal in the received transmission frame with, the demodulator,
(21)

A transmission system including:

a transmission device configured to transmit a transmission frame made up of a payload storing broadcast content and a prescribed signal, outside the payload, including emergency alert information; and

a reception device configured to display the emergency alert information obtained by demodulating the prescribed signal in the received transmission frame.

### REFERENCE SIGNS LIST

1 emergency alert information transmission system
100 information providing device
200 transmission device
201 emergency alert information reception unit
202 emergency alert information processing unit
203 program conte content acquisition unit
204 broadcast signal generation unit
205 broadcast signal transmission unit
300 reception device
701 antenna
702 tuner
703 demodulator
704 buffer
705 control with (SoC)
706 display unit
707 speaker
711 signal line for payload data transmission
712 control bus (I²C interface)
713 boot trigger signal

1. A transmission device comprising:
an emergency alert information acquisition unit configured to acquire emergency alert information;
a broadcast content acquisition unit configured to acquire broadcast content;,
a transmission frame generation unit configured to generate a transmission frame made up of a payload storing the broadcast content and a prescribed signal, outside the payload, including the emergency alert Information; and
a transmission unit configured to transmit the transmission frame.

2. The transmission device according to claim 1, wherein
the transmission unit transmits the transmission frame on a broadcast channel -assigned to a broadcasting station.

3. The transmission device according to claim 1, wherein
the transmission frame generation unit inserts the prescribed signal in a preamble preceding the payload in the transmission frame.

4. The transmission device according to claim 1, wherein
the transmission frame generation unit generates the prescribed signal including tuning data used for tuning on a receiving side, and storing the emergency alert, information in a surplus portion.

5. The transmission device according to claim 1, wherein
the transmission frame generation unit stores emergency alert information having a predefined message and expressed in a binary format in one prescribed signal.

6. The transmission device according so claim 1, wherein
the transmission frame generation unit stores one of the emergency alert information using a plurality of prescribed signals.

7. The transmission device according to claim 1, wherein
the transmission frame generation unit stores emergency alert information made up of text using a plurality of prescribed signals.

8. The transmission device according to claim 1, wherein
the transmission frame generation unit stores emergency alert information made up of a designated file format using a plurality of prescribed signals.

9. The transmission device according to claim 8, wherein
the emergency alert information acquisition unit acquires emergency alert information made up of a designated file format,
the transmission device further includes an emergency alert information processing unit configured to perform filtering or format conversion on the emergency alert information made up of a designated file format, and
the transmission frame generation unit stores the emergency alert information processed by the emergency alert information processing unit in the prescribed signal.

10. The transmission device according to claim 1, wherein
the transmission frame generation unit uses one format from among a format of storing emergency alert information having a predefined message and expressed in a binary format in one prescribed signal, a format of storing emergency alert information made up of text using a plurality of prescribed signals, and a format of storing emergency alert information made up of a designated file format using a plurality of prescribed signals, and specifies the format to use inside a prescribed signal.

11. A transmission method comprising:
an emergency alert information acquiring step of acquiring emergency alert information;
a broadcast content acquiring step of acquiring broadcast contest;
a transmission frame generating step of generating a transmission frame made up of a payload storing the broadcast content and a prescribed signal, outside the payload, including-the emergency alert information; and
a transmitting step of transmitting the transmission frame.

12. A reception device comprising:
a reception unit configured to receive a transmission frame made up of a payload storing broadcast content and a prescribed signal, outside the payload, including emergency alert information;
a demodulator configured to demodulate the received transmission frame,
a display unit configured to display an image; and
a control unit configured to control the display unit, wherein
the control unit causes the display unit to display the emergency alert information obtained by demodulating the prescribed signal in the received transmission frame with the demodulator.

13. The reception device according to claim 12, wherein
the reception unit receives the transmission frame by tuning to a desired broadcast channel.

14. The reception device according to claim 12, wherein
the reception unit receives the transmission frame including the prescribed signal in a preamble preceding the payload.

15. The reception device according to claim 12, further comprising:
an audio output unit configured to output audio, wherein
the control unit causes the audio output unit to output audio of the emergency alert information obtained by demodulating the prescribed signal with the demodulator.

16. The reception device according to claim 12, further comprising:
a buffer configured to temporarily store the emergency alert information obtained by demodulating the prescribed signal with the demodulator, wherein
the control unit reads the emergency alert information from the buffer via a serial interface.

17. The reception device according to claim 12, wherein
the control unit waits in a standby state, and
the demodulator, upon obtaining valid emergency alert information from the received transmission frame, activates the control unit by outputting a boot trigger signal.

18. The reception device according to claim 12, wherein
the demodulator intermittently activates and checks for the prescribed signal in the received transmission frame.

19. A reception method comprising;
a receiving step of receiving a transmission frame made up of a payload storing broadcast content and a prescribed signal, outside the payload, including emergency alert information;
a demodulating step of demodulating the received transmission frame; and
a displaying step of displaying, on the display unit, the emergency alert information obtained by demodulating the prescribed signal in the received transmission frame.

20. A computer program stated in a computer-readable format so as to cause a computer to function as:
a reception unit configured to receive a transmission frame made up of a payload storing broadcast content and a prescribed signal, outside the payload, including emergency alert information;
a demodulator configured to demodulate the received transmission frame;
a display unit configured to display an image; and
a control unit configured to cause the display unit to display the emergency alert information obtained by demodulating the prescribed signal in fee received transmission frame with the demodulator.
